(19) United States
(12) Patent Application Publication
(10) Pub. No.: US 2025/0051131 A1
(43) Pub. Date: Feb. 13, 2025

(54) DEVICE FOR MEASURING A FORCE ACTING ON AN ELEVATOR SYSTEM, METHOD FOR MEASURING A FORCE ACTING ON A MOVABLE COMPONENT OF AN ELEVATOR SYSTEM, AND AN ELEVATOR SYSTEM FOR CARRYING OUT THE METHOD

(71) Applicant: Inventio AG, Hergiswil (CH)

(72) Inventors: Romeo Lo Jacono, Gravesano (CH); Gilles Trottman, Meierskappel (CH); Eric Wang, Luzern (CH)

(21) Appl. No.: 18/719,294

(22) PCT Filed: Dec. 19, 2022
(86) PCT No.: PCT/EP2022/086538

§ 371 Date: Jun. 13, 2024

(30) Foreign Application Priority Data
Dec. 20, 2021 (EP) 21215981.8

(51) Int. Cl. B66B 1/34; G01L 5/04; G01L 25/00

(52) U.S. Cl. CPC B66B 1/3476; B66B 1/3461; G01L 5/04; G01L 25/00

(57) ABSTRACT

A device for an elevator system has a blocking arrangement and a measuring arrangement, wherein the blocking arrangement connects a counterweight and/or a car of the elevator system to a rail system of the elevator system, and wherein the measuring arrangement maps a force transferred from the counterweight and/or car into the rail system as a force value.

### FIELD

The present invention relates to a device for an elevator system, to a method for measuring a force acting on at least one counterweight and/or a car (hereinafter also summarized as a movable component of an elevator system), and to an elevator system.

### BACKGROUND

An elevator system has vertically movable components such as a car and at least one counterweight. The movable components are connected to each other via at least one suspension means. The suspension means runs over at least one drive roller of a drive unit of the elevator system. The suspension means carries a constant weight of the counterweight on one side of the drive roller. On the other side, the suspension means carries the variable weight of the car and a load to be transported in the car. The drive unit applies a torque to compensate for a difference between the weights. The torque is transmitted to the suspension means by the friction or traction between the suspension means and the drive roller.

Functionalities of the elevator system must be checked prior to its commissioning and/or as part of maintenance work. The elevator system may, in particular, have a load sensor that may be used to determine a current load on the elevator car, for example by measuring a load acting between the elevator car and the suspension means. The car may be loaded with a known additional weight to test the functionality of the load sensor. The additional weight may be introduced into the car in the form of lead blocks, for example. Since the additional mass of the lead blocks is known, an additional weight acting on the suspension means is also known.

WO2008071301A1 describes a method and a device for testing elevator systems.

WO2010089337A1 describes a device for carrying out a load test in an elevator system and a method for carrying out such a test.

WO2013068648A1 describes a method and a device for measuring a balance of an elevator and a method for balancing the elevator.

WO2021084012A1 discloses a car brake of an elevator system.

DE4311011A1 describes a method and a device for testing an elevator.

### SUMMARY

There may be a need, inter alia, for an improved device and method for measuring a force acting on a movable component of an elevator system. There may also be a need for an improved way to calibrate a load sensor of an elevator system. There may also be a need for an elevator system in which a method for measuring a force may be carried out.

Such a need may be met by a device, a method for measuring a force acting on a movable component of an elevator system, and an elevator system according to the advantageous embodiments defined and described in the description.

With the approach presented herein the additional weight which is traditionally used to change the tensile force between the drive roller and the car, for example by means of lead blocks, is eliminated. Instead of the known additional weight in the car, one of the movable components is temporarily fixed, for example, to a rail system of the elevator system, and a tensile force in the suspension means is changed. The tensile force may also be reduced other than by the additional weight. During this process, a force resulting from the changed tensile force is measured at the fixed component.

A load sensor or force sensor on the car or counterweight may be calibrated using the measured force. Furthermore, a mass corresponding to an overload may be mimicked by the device, for example to carry out an integrity test of the elevator system.

By measuring the force acting on the fixed component, there is no need to provide and remove the additional weight or to load and unload the car with the additional weight. All that is required to measure the force is at least one easily transportable device presented herein that has a blocking arrangement and a measuring arrangement.

According to a first aspect of the invention, a device for an elevator system is presented, wherein the device has a blocking arrangement and a measuring arrangement, wherein the blocking arrangement is configured to connect (fasten) a movable component of the elevator system to a rail system of the elevator system and/or to support it on the rail system, wherein the measuring arrangement is configured to map a force transferred from the movable component into the rail system as a force value.

According to a second aspect of the invention, a method for measuring a force acting on at least one counterweight and/or a car of an elevator system is presented, wherein the elevator system comprises at least one elevator controller, a guide rail and at least one counterweight and a car, wherein the at least one counterweight is connected to the car via at least one suspension means, the method comprising the steps of:
connecting at least one device according to one aspect of the invention to the at least one guide rail;
placing the at least one counterweight and/or the car onto the at least one device;
changing a tensile force transmitted to the at least one counterweight and/or the car via suspension means;
recording a force value on the basis of a force transferred to the rail system via the device.

According to a third aspect of the invention, an elevator system with at least one, preferably two, counterweight(s), a car and an elevator controller is presented, wherein the elevator controller is configured to connect to a device according to a first aspect of the invention and to carry out a method according to a second aspect of the invention.

A blocking arrangement may essentially completely prevent a movement of the at least one counterweight and/or the car along the guide rail, at least in one direction. The direction may, in particular, be a vertical direction. In this direction, the blocking arrangement may present an insurmountable obstacle for the movable component (at least one counterweight and/or the car). The blocking arrangement may transfer compressive forces and/or tensile forces exerted by the movable component into the rail system.

The blocking arrangement may have at least one hook to be inserted into a corresponding recess in the rail system. The hook may be inserted into the recess and moved along the recess until a contact surface of the hook abuts an edge of the recess. The force may be transferred into the rail system via the hook. The hook may allow for mounting and dismounting the device without tools. The rail system may have several matching recesses. The device may thus be attached at different positions of the rail system. The blocking arrangement may, in particular, have multiple hooks of the same type. Multiple hooks may be used to achieve redundancy and increase the operational reliability of the device. Also, multiple hooks allow for a greater force to be transferred into the rail system.

The at least one hook may be designed to be symmetrical. The hook may thus be inserted into the recess in opposite orientations. Alternatively or additionally, the symmetrical hook may transfer tensile forces of the suspension means upward and the weight of the movable component downward into the rail system. When the direction of force is changed, the hook may slide in the recess until the opposite side of the hook abuts the opposite side of the recess. This allows the device to be supported upward and downward on the rail system.

The blocking arrangement may have a car side and a counterweight side for connecting to the rail system. The measuring arrangement may be used on a car of the elevator system if the car side is connected to the rail system. Alternatively, the measuring arrangement may be used on a counterweight of the elevator system if the counterweight side is connected to the rail system. A car guide of the rail system may differ from a counterweight guide of the rail system. The car side may be adapted to the car guide. The counterweight side may be adapted to the counterweight guide. The car side and the counterweight side may be connected to the rail system on different sides of the rail system.

The measuring arrangement can be configured such that the force value may be transmitted in the form of a signal to a controller of the elevator system. That way, the device may be connected to the elevator controller. This allows for at least partial automation of the methods in which the measuring arrangement of the device is used. This may be implemented, for example, by means of a cable connection and/or a wireless connection.

The device may be configured such as to further comprise a display for showing the force values measured by the measuring arrangement. Thus, when using the device for measuring tensile forces, the force value set and displayed accordingly in a static state may be read and used, for example, by entering it at the elevator controller.

Alternatively or additionally, according to one embodiment, the device may be connected to the counterweight and/or car by means of a screwing device.

Alternatively or additionally, the device comprises a screwing device with which a tensile force transmitted to the at least one counterweight and/or the car via suspension means may be changed in the mounted state.

According to one embodiment, the screwing device has a thread, preferably a threaded rod, via which the counterweight and/or car may be moved a defined distance in order to change the tensile force. Preferably, the counterweight and/or car may be lifted via the screwing device in order to reduce the tensile force. Preferably, the counterweight and/or car may alternatively or additionally be pushed downward or pulled downward by the screwing device in order to increase the tensile force.

An elevator system can be a passenger transport system. The elevator system can have at least one counterweight per car. The elevator system may, in particular, have two counterweights per car. At least one suspension means is arranged between the car and the counterweights. The suspension means may be a cable or a belt, for example. The suspension means may be guided over at least one drive roller of a drive unit of the elevator system. The drive roller may be arranged at an upper end of a rail system of the elevator system. The counterweights may be moved in the opposite direction to the car.

The rail system may have at least one guide per car and at least one guide per counterweight. The rail system may, in particular, have two parallel running, vertical guide rails between which the car is mounted so as to be vertically movable. Each guide rail may have a guide for one of the counterweights on an outer side.

The device may be temporarily connected to the rail system. The device may also be connected to another static element, such as a rail bracket or a shaft wall. The device may be mechanically connected to the rail system. For example, the device may be bolted to the guide rail or clamped to the guide rail. In case of two guide rails, the devices may be used in pairs. The guide rail may have at least one predefined attachment point for the device, at which the device may be positively connected to the guide rail. The device may be connected to the car in the immediate vicinity of a car brake of the elevator system. This means that the force measured by the measuring arrangement may correspond more precisely to the actual force at the load sensor, which is integrated into the car brake. The device may be arranged above or below the movable component.

A measuring arrangement may be a load cell or a weighing beam, for example. The measuring arrangement may be arranged between an interface of the device with the rail system and an interface of the device with the movable component. An acting force may deform the measuring arrangement slightly elastically. The deformation may be mapped as an electrical signal. The signal may represent the force. The measuring arrangement may be calibrated. For example, the measuring arrangement may be set to zero before the movable component is fixed.

The tensile force may be increased or reduced.

The tensile force may be changed by using a screwing device of the device. The screwing device may have a thread via which the movable component may be moved a defined distance in order to change the tensile force. The component may be lifted using the screwing device in order to reduce the tensile force. The component may also be pushed downward or pulled downward by the screwing device in order to increase the tensile force.

Alternatively or additionally, the tensile force may be changed via a torque of the drive unit provided by the traction sheave. The torque may be changed via a motor control of the drive unit. The torque may also be changed by a brake on the traction sheave. A magnitude of change may be specified to the motor control unit and/or an actual change in torque may be measured and output by the motor control unit.

The component may be mechanically connected to the device connected to the rail system. The device may be connected to the rail system below the movable component and may be connected to the movable component from below. The mechanical connection allows for the tensile force of the suspension means to be increased without the component lifting off the device. The device may also be connected to the rail system above the movable component and may be mechanically connected to the movable component from above. The movable component may then be suspended from the device and the suspension means may be relieved. The component may also be pushed downward by the device. Work on the elevator may also be carried out safely as a result of the mechanical fixation.

The tensile force may be increased such as to be greater than a nominal load of the elevator system. The tensile force may, in particular, be increased such as to be greater than 120% of the nominal load of the elevator system. A nominal load may represent the maximum permissible load for the elevator system during operation. An overload situation may be simulated by increasing the tensile force. Due to the increased tensile force, many safety-relevant parts of the elevator system are subjected to greater loads than during operation of the elevator system. If the parts may withstand the increased tensile force, safe operation up to the nominal load may be assumed. The load sensor may prevent operation with a load greater than the nominal load, for example by not releasing the car brake as long as the load is greater than the nominal load.

The device may also be used without measuring the acting force. The device may then be used as an easy-to-handle blocking arrangement to ensure a high level of work safety.

A load sensor may be calibrated in a further method step. For this purpose, a force value is recorded using a method as described above and below, wherein the changed tensile force is mapped as a load value using the load sensor, wherein a comparison is made between the load value and the force value and the load sensor is calibrated using a result of the comparison.

Using the load sensor, the tensile force of the suspension means may be mapped as a reference value when the component is freely suspended from the suspension means. The comparison may also be performed using the reference value. The reference value may be used to evaluate a change in the load value when the tensile force changes. By evaluating the change, an amplification factor for the load value may be determined, for example.

The tensile force may be changed at least one more time using the drive unit. At least one further measured value of the load sensor and/or of the device may be recorded. The comparison may also be performed using the at least one further measured value. In particular, value pairs of measured values and associated tensile forces may be recorded. A calibration curve for the load sensor may be determined using several measured values with different tensile forces or pairs of values. Using the calibration curve, the load value may be linearized over a wide range of values.

A load sensor may also be designed as a load cell or weighing beam. The load sensor may be arranged at an interface between the suspension means and the car. The load sensor may be integrated in a braking mechanism of the car. The car may also have several load sensors.

A load value measured by the load sensor may be compared with a known value in order to calibrate the load sensor. If the load value deviates from the known value, a correction factor may be determined and the load value may be corrected using the correction factor.

It should be noted that some of the possible features and advantages of the invention are described herein with reference to different embodiments of methods on the one hand and of devices on the other. A person skilled in the art will recognize that the features can be suitably combined, adapted, or exchanged in order to arrive at further embodiments of the invention.

Embodiments of the invention will be described below with reference to the accompanying drawings, wherein neither the drawings nor the description are intended to be interpreted as limiting the invention.

### DESCRIPTION OF THE DRAWINGS

FIGS. 1a and 1b show representations of a device according to an exemplary embodiment; and

FIG. 2 shows a representation of a calibration of a load sensor according to an exemplary embodiment.

The drawings are merely schematic, and not to scale. The same reference signs indicate the same or equivalent features.

### DETAILED DESCRIPTION

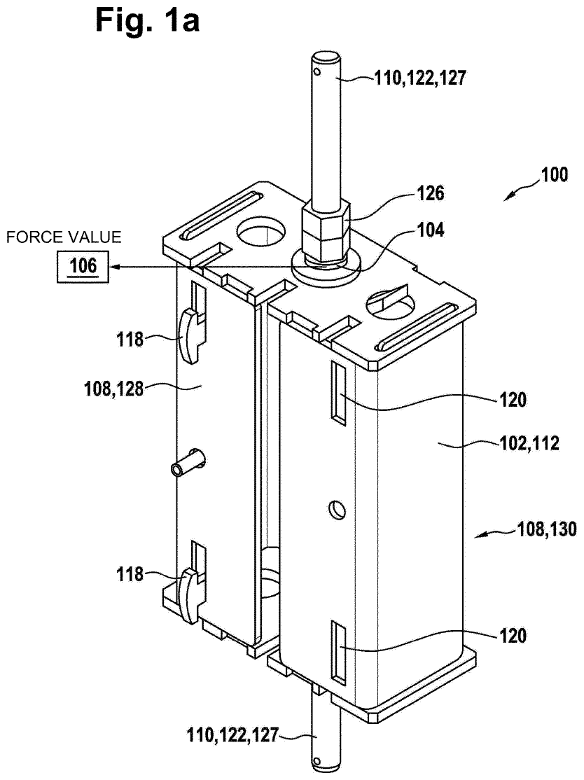

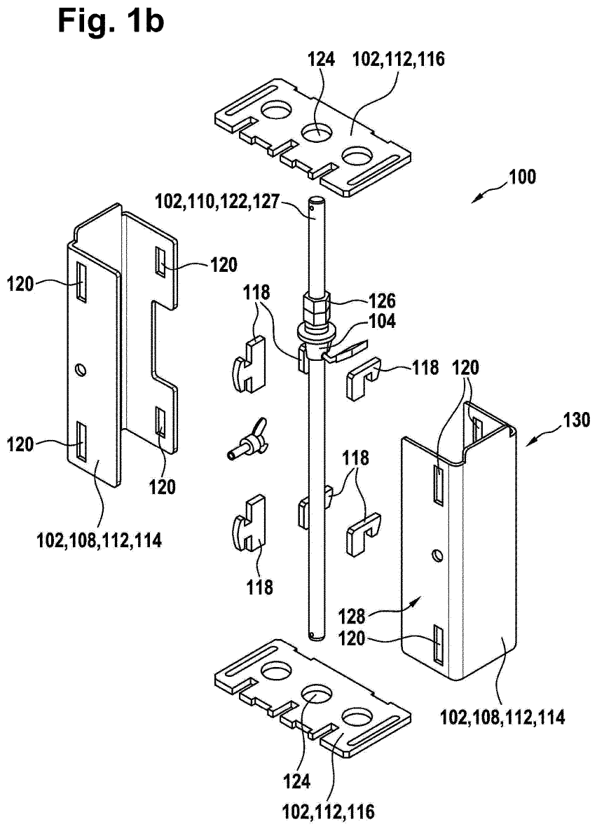

FIG. 1a shows a perspective representation of a device 100 according to an exemplary embodiment. FIG. 1b shows an exploded view of the device 100.

The device 100 comprises a blocking arrangement 102 and a measuring arrangement 104. The blocking arrangement 102 is configured to be mechanically connected to a rail system of an elevator system and to support, on the rail system, a component of the elevator system that is movably mounted on the rail system, for example a car or a counterweight, or to fasten it to the rail system and to transfer a force from the movable component into the rail system. The measuring arrangement 104 is configured to map the force transferred from the movable component via the blocking arrangement 102 into the rail system as a force value 106.

The blocking arrangement 102 has at least one rail interface 108 for connecting to the rail system and at least one component interface 110 for connecting to the component. The measuring arrangement 104 is arranged between the rail interface 108 and the component interface 110.

The device 100 has a substantially cuboid housing 112 composed of stamped and bent parts. The housing 112 has two side parts 114 and two covers 116. The side parts 114 are bent in a U-shape and are each connected to one of the covers 116 at opposite end faces. The side parts 114 and the covers 116 enclose an interior of the device 100. The side parts 114 and the covers 116 are made of metal.

The rail interface 108 has hooks 118 to be inserted into corresponding recesses in the rail system. The hooks 118 are designed as stamped parts made from a sheet material. The hooks 118 are also made of metal. The hooks 118 protrude from slots 120 in the side parts 114 and may be inserted into corresponding elongate recesses in the rail system. After insertion, the hooks 118 may be moved along the recess until they engage around an edge of the respective recess in the rail system and fix the device 100 at the edge.

The component interface 110 has a threaded rod 122. The threaded rod 122 is made of metal. The threaded rod 122 runs through the interior and through one hole 124 per cover 116. At least two nuts 126 are screwed onto the threaded rod 122. The threaded rod 122 is supported on at least one of the covers 116 by the nuts 126. A length of the threaded rod 122 protruding from the housing 112 may be varied. Depending on the application, different lengths of threaded rod 122 may be set.

The measuring arrangement 104 is arranged on the threaded rod 122 between the nuts 126 and the cover 116.

The length of the threaded rod 122 may also be changed once the component is arranged on the device 100. The threaded rod 122 may then be referred to as a screwing device 127. The component may be moved a certain distance by changing the length. While the component is being moved, a tensile force or compressive force is exerted on the component, which may be mapped by the measuring arrangement 104 as the force value 106.

Alternatively or additionally, the threaded rod 122 may also be screwed into a thread of the component. When used as a screwing device 127, the threaded rod 122 may be rotated in the thread of the component to move the component by the distance and apply the force to the component.

In one exemplary embodiment, the blocking arrangement 102 has two rail interfaces 108. The two rail interfaces 108 are arranged on opposite sides of the housing 112. One rail interface 108 is configured as a car side 128. The other rail interface 108 is configured as a counterweight side 130. When the car side 128 is connected to the rail system, the component interface 110 may be connected to the car of the elevator system. When the counterweight side 130 is connected to the rail system, the component interface 110 may be connected to the counterweight of the elevator system.

In one exemplary embodiment, the hooks 118 on the car side 128 are designed as symmetrical double hooks. The double hooks may thus transfer forces, which act on the blocking arrangement 102 from opposite directions, into the rail system.

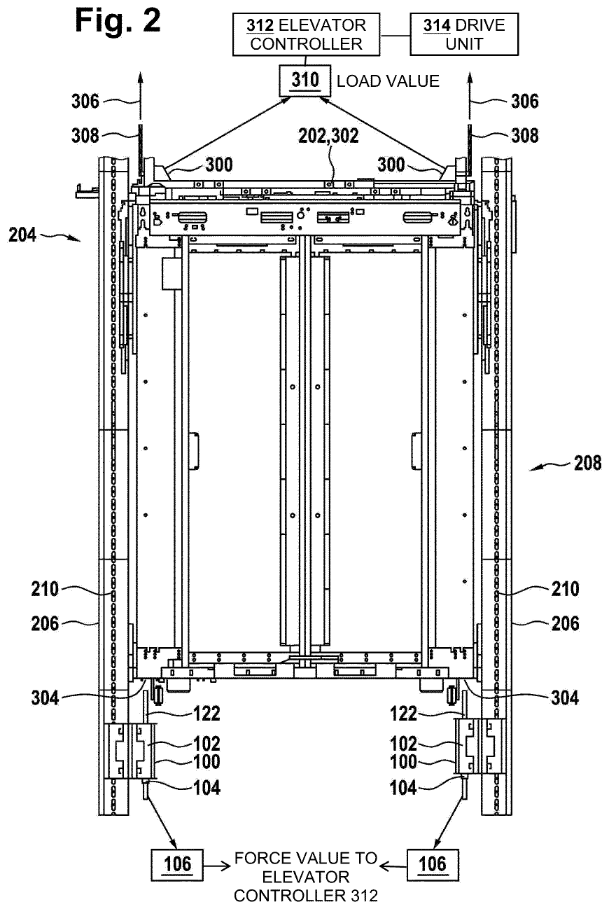

In one exemplary embodiment (not shown), the device 100 has an interface for establishing a communication connection between the device 100 and an elevator controller 312 (see FIG. 2). This interface may be designed as a wireless connection or as a wired connection, for example. In another exemplary embodiment, the device 100 has a display for displaying the measured values measured by the measuring arrangement 104. In yet another alternative embodiment, the measured values are transmitted wirelessly to a display unit in order to be displayed. The display unit may be configured as a smartphone.

FIG. 2 shows a representation of a calibration of at least one load sensor 300 according to an exemplary embodiment. Calibration is carried out using a device 100 according to the approach presented herein. The device 100 substantially corresponds to the device of FIGS. 1a and 1b. Calibration is shown herein on two load sensors 300 of a car 302 as the movable component 202 of the elevator system 204. In another exemplary embodiment (not shown), the load sensor 300 is implemented twice on each of two car brakes. In this exemplary embodiment, the load sensor 300 is formed on the suspension of the car brake.

For calibration, the blocking arrangement 102 of at least one device 100 is mechanically connected to the rail 206 of the rail system 208 of the elevator system 204. For this purpose, the hooks of the car side of the rail interface of the blocking arrangement 102 are inserted into recesses 210 of the rail 206. The blocking arrangement 102 thus blocks a travel path of the car 302 along the rail 206. The measuring arrangement 104 is arranged on an underside of the device 100. Here, two devices 100 are connected at the same height to two rails 206 of the rail system 208, since the car 302 is guided vertically by both rails 206 and thus tilting of the car 302 may be avoided. In another exemplary embodiment (not shown), only the one device 100 is present.

For measuring, the car 302 is moved adjacent to the devices 100 by the drive unit 314 and the threaded rods 122 of the component interfaces 110 are each screwed into a thread 304 of the car 302 from below. The car 302 is now mechanically connected to the devices 100.

The drive unit 314 then increases a tensile force 306 in the at least one suspension means 308. Alternatively, the tensile force 306 may be increased by further tightening the threaded rods 122 in the threads 304 and/or by tightening the nuts. This lifts the devices 100 until the double hooks of the car sides of the rail interfaces have moved upwards in the recesses 210 of the rail 206 to engage around the upper edges of the recesses 210. The rail interfaces may now introduce tensile forces into the rails 206.

The tensile force 306 is increased until a predetermined value is reached. The load sensors 300 map this tensile force as one load value 310 each. The measuring arrangements 104 also map the proportionate forces transmitted by the blocking arrangements 102 into the rails 206 as force values 106.

The force values 106 are added together and compared with the load values 310, for example, by the elevator controller 312. If a sum of the load values 310 deviates from the sum of the force values 106, a calibration of the load sensors 300 is adjusted accordingly.

In one exemplary embodiment, the tensile force 306 is then further increased. For example, the tensile force 306 may be increased to 125% of a value that is normal during operation of the elevator system 204. The load sensors 300 and the measuring arrangements 104 also map the increased tensile force as measured values, which are then again compared with each other. Calibration is complete if the load values 310 of the calibrated load sensors 300 are within a tolerance range around the force values 106. If one of the load values is outside the tolerance range, a magnification factor of the load sensor 300 may be adjusted, for example. The tolerance range may be 15 percent, for example.

Alternatively, it is possible to communicate the force values determined by the measuring arrangement 104 to the elevator controller 312 (by device(s) connected to the elevator controller or by inputting the measured values read by the device 100 into the elevator controller), wherein the two measuring points (first tensile force, second tensile force) are thus linked to the associated load sensor signals or assigned to them. If a calibrated device is used, the load sensor 300 or the load sensors 300 may be calibrated in this way.

After calibration, the tensile force 306 is reduced again until the double hooks have moved back down into the recesses 210 and the devices 100 are again secured against falling. The threaded rods 122 are then unscrewed from the threads 304 and the devices 100 are removed from the rail system 208.

The measuring arrangement may also be removed from the device and the blocking arrangement may be used without the measuring arrangement as a safety mechanism for fixing one of the movable components. For example, maintenance work on the elevator system may be carried out safely.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A device for measuring a force acting on an elevator system, the elevator system including a movable component that moves along a rail system of the elevator system, the device comprising:
a blocking arrangement adapted to connect the movable component to the rail system of the elevator system;
a measuring arrangement arranged at the blocking arrangement; and
wherein, when the movable component is connected to the rail system by the blocking arrangement, the measuring arrangement maps a force transferred from the movable component into the rail system as a force value.

17. The device according to claim 16 wherein the blocking arrangement includes a hook adapted to be inserted into a corresponding recess in the rail system to connect the blocking arrangement to the rail system.

18. The device according to claim 17 wherein the hook has a symmetrical shape enabling the hook to be inserted into the recess in opposite orientations.

19. The device according to claim 16 wherein the movable component is an elevator car or a counterweight, the blocking arrangement having a car side and a counterweight side, when the car side is connected to the rail system and the elevator car is connected to the blocking arrangement the measuring arrangement maps the force transferred from the elevator car, and when the counterweight side is connected to the rail system and the counterweight is connected to the blocking arrangement the measuring arrangement maps the force transferred from the counterweight.

20. The device according to claim 16 wherein the measuring arrangement maps the force as an electrical signal representing the force value and adapted for transmission to an elevator controller of the elevator system.

21. The device according to claim 16 including a screwing device extending from the blocking arrangement, the screwing device adapted to connect to the movable component.

22. The device according to claim 21 wherein the screwing device, when connecting the movable component to the rail system through the blocking arrangement, is adapted to selectively change a tensile force transmitted to the movable component by a suspension means of the elevator system.

23. The device according to claim 22 wherein the screwing device includes a threaded rod adapted to move the movable component a defined distance to change the tensile force, wherein the movable component is lifted by the screwing device to reduce the tensile force and the movable component is moved downward by the screwing device to increase the tensile force.

24. A method for measuring a force acting on a movable component of an elevator system, the elevator system including an elevator controller that controls movement of the movable component, the movable component being guided by a rail and being connected to a suspension means, the method comprising the steps of:
connecting the device according to claim 16 to the rail;
placing the movable component onto the device;
changing a tensile force transmitted to the movable component by the suspension means; and
recording a force value by the measuring arrangement based on a force transferred to the rail by the device.

25. The method according to claim 24 wherein the movable component is an elevator car or a counterweight.

26. The method according to claim 24 including changing the tensile force using a screwing device included in the device and/or using a drive unit of the elevator system.

27. The method according to claim 24 including mechanically connecting the movable component to the device.

28. The method according to claim 24 including changing the tensile force by increasing the tensile force to be greater than a nominal load of the elevator system.

29. The method according to claim 28 including increasing the tensile force to be greater than 120% of the nominal load of the elevator system.

30. The method according to claim 24 wherein the movable component includes a load sensor of the elevator system and including a step of calibrating the load sensor by recording the force value by the measuring arrangement, mapping the changed tensile force as a load value using the load sensor, comparing the load value and the force value, calibrating the load sensor using a result of the comparison, and/or using the load sensor to map the tensile force of the suspension means as a reference value when the movable component is freely suspended from the suspension means, and comparing the load value and the reference value to evaluate a change in the load value when the tensile force changes.

31. The method according to claim 30 including changing the tensile force transmitted to the movable component by the suspension means again and recording a further measured value of the load sensor load value and/or of the device force value, and performing the comparing using the further measured value.

32. An elevator system comprising:
at least one counterweight;
an elevator car connected to the at least one counterweight; and
an elevator controller adapted to perform the method according to claim 24.
